(19) United States
(12) Patent Application Publication
(10) Pub. No.: US 2015/0149919 A1
(43) Pub. Date: May 28, 2015

(54) INFORMATION PROCESSING SYSTEM AND METHOD OF PROCESSING INFORMATION

(71) Applicant: Takaya MATSUISHI, Kanagawa (JP)

(72) Inventor: Takaya MATSUISHI, Kanagawa (JP)

(73) Assignee: RICOH COMPANY, LTD., Tokyo (JP)

(21) Appl. No.: 14/549,688

(22) Filed: Nov. 21, 2014

(30) Foreign Application Priority Data
Nov. 26, 2013 (JP) 2013-243854
Nov. 14, 2014 (JP) 2014-231266

(51) Int. Cl. G06F 3/0484; G06F 3/0481

(52) U.S. Cl. CPC G06F 3/0484; G06F 3/0481
USPC 715/739

(57) ABSTRACT

An information processing system including at least one computer includes a receiving unit that receives user identification information from an apparatus connected through a network; a returning unit that returns a portion which is associated with the user identification information received by the receiving unit out of screen information which is stored in association with the apparatus and is common to a plurality of users in response to an acquisition request to acquire the screen information from the apparatus; and a processing unit that receives a request which is sent from the apparatus in response to an input into a screen displayed based on the returned portion.

### BACKGROUND OF THE INVENTION

1. Field of the Invention

The present invention relates to an information processing system and a method of processing information.

2. Description of the Related Art

There is provided a service served from an apparatus such as an image forming apparatus through a network, for example, a cloud service. For example, image data scanned by the apparatus can be uploaded into a predetermined online storage or the like through the cloud service.
Patent Document 1: Japanese Laid-Open Patent Publication No. 2007-293654

For example, from the viewpoint of securing security or the like, it is convenient to provide a limitation for each user to an operation of an operation screen displayed on the apparatus in using such a service.

### SUMMARY OF THE INVENTION

The present invention is provided in consideration of the above points, and it is an object of at least one embodiment of the present invention to improve flexibility of a limitation to an operation of a screen in enabling to use a service provided through a network.

One aspect of the embodiments of the present invention may be to provide an information processing system including at least one computer including a receiving unit that receives user identification information from an apparatus connected through a network; a returning unit that returns a portion which is associated with the user identification information received by the receiving unit out of screen information which is stored in association with the apparatus and is common to a plurality of users in response to an acquisition request to acquire the screen information from the apparatus; and a processing unit that receives a request which is sent from the apparatus in response to an input into a screen displayed based on the returned portion.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary structure of an information processing system of a first embodiment;

FIG. 2 illustrates an exemplary hardware structure of a service providing apparatus of the first embodiment;

FIG. 3 illustrates an exemplary functional structure of a service providing apparatus of the first embodiment;

FIG. 4 is a diagram for explaining a conceptual model of a profile;

FIG. 5 illustrates an exemplary functional structure of the apparatus of the first embodiment;

FIG. 6 is a sequence chart for explaining an exemplary procedure of a setup process related to access permissibility to all users in a group of the first embodiment;

FIG. 7 illustrates an exemplary structure of a user information memory unit;

FIG. 8 illustrates a structural example of a profile memory unit;

FIG. 9 is an example of a displayed main screen;

FIG. 10 is an example of displaying a screen for selecting a user having an access permit;

FIG. 11 illustrates an exemplary structure of a memory unit for a user having an access permit;

FIG. 12 is a sequence chart illustrating a procedure at a time of performing a job of a cloud scan service of the first embodiment;

FIG. 13 illustrates an exemplary structure of a profile-apparatus-correspondence memory unit;

FIG. 14 illustrates an exemplary operation screen displayed based on profile information;

FIG. 15 is a sequence chart for explaining an exemplary procedure of a job of the cloud scan service related to an apparatus to which a profile requiring no authentication is allocated;

FIG. 16 illustrates an exemplary structure of the information processing system of a second embodiment;

FIG. 17 illustrates an exemplary functional structure of a service providing apparatus of the second embodiment;

FIG. 18 illustrates an exemplary functional structure of user information administration apparatus of the second embodiment;

FIG. 19 illustrates an exemplary structure of a tenant information memory unit;

FIG. 20 is a sequence chart for explaining an exemplary procedure of a setup process related to access permissibility for all the users in a group of the second embodiment; and

FIG. 21 is a sequence chart illustrating an exemplary procedure at a time of performing a job of a cloud scan service of the second embodiment.

### DETAILED DESCRIPTION OF THE PREFERRED EMBODIMENTS

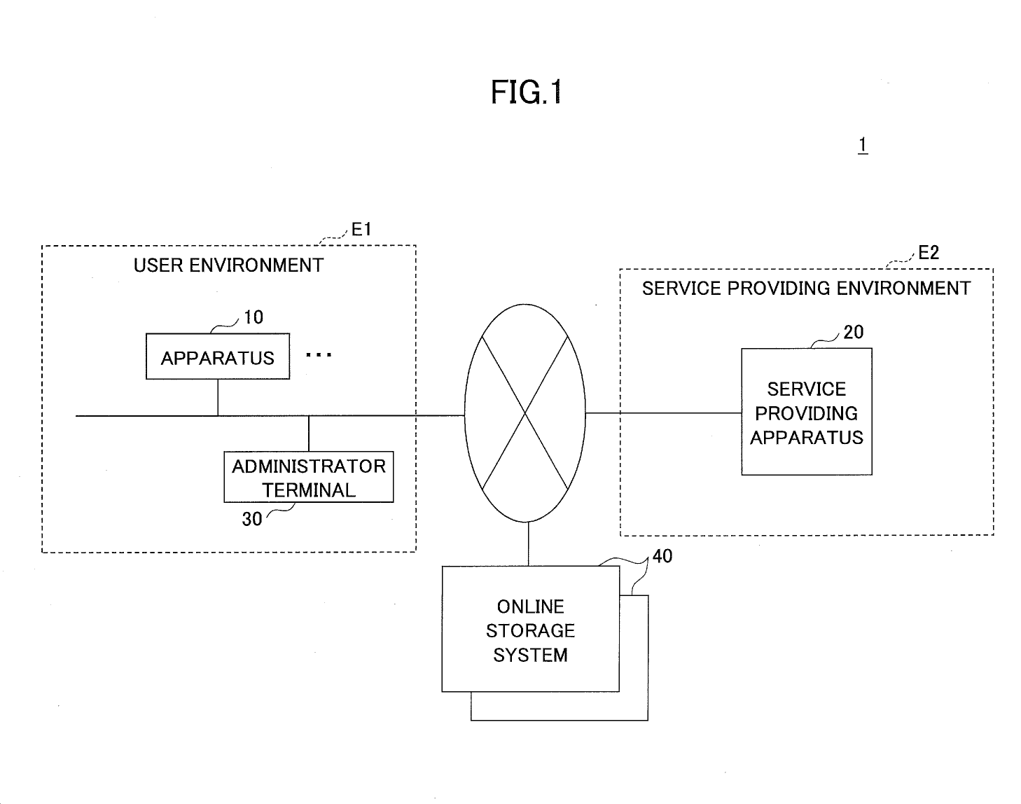

A description is given below, with reference to the FIG. 1 through FIG. 21 of embodiments of the present invention. Where the same reference symbols are attached to the same parts, repeated description of the parts is omitted.

Reference symbols typically designate as follows:
1,2: information processing system;
10: apparatus;
11: client application;
12: application platform;
20: service providing apparatus;
30: administrator terminal;
40: online storage system;
50: user information administration apparatus;
200: drive device;
201: recording medium;
202: auxiliary memory device;
203: memory device;
204: CPU;
205: interface device;
220L: application layer;
221p: portal application;
222p: scan application;
230L: domain inherent service layer;
231p: scan logic unit;
240L: common service layer;
241p: authentication unit;
242p: user administration unit;
250L: database layer;
251p: tenant information memory unit;
252p: user information memory unit;
253p: apparatus information memory unit;
254p: profile memory unit;
255p: memory unit for user having access permit;
256p: profile-apparatus-correspondence memory unit;
280: platform API; and
290: domain inherent API.

### First Embodiment

FIG. 1 illustrates an exemplary structure of an information processing system of a first embodiment. In the information processing system 1 illustrated in FIG. 1, a service providing environment E2, a user environment E1, an online storage system 40, and so on are communicable through a wide area network such as the Internet.

The service providing environment E2 is a system environment in an organization which provides a cloud service through the network. Within the first embodiment, the cloud service is specifically described. However, the first embodiment can be applied to a service provided by a service provided through the network such as a service provided by an application service provider (ASP), a web service, and so on.

The service providing environment E2 includes a service providing apparatus 20. The service providing apparatus 20 provides a predetermined service through the network. One of the services provided by the service providing apparatus 20 is a “cloud scan service”. The cloud scanning service is a service of delivering image data obtained by scanning in the apparatus 10 and transferred from the apparatus 10 to a predetermined storage. Said differently, the service providing apparatus 20 may be installed in the user environment E1. Said differently, the service providing environment E2 may be included in the user environment E1.

The user environment E1 is a system environment of the apparatus 10 in an organization of a user enterprise or the like. In the user environment E1, at least one apparatus 10 is connected to an administrator terminal 30 through a network such as a local area network (LAN) or the like. The apparatus 10 of the first embodiment is an image forming apparatus having a scan function. The apparatus 10 may be a multifunction peripheral having a print function, a copy function, a facsimile (FAX) communication function, or the like in addition to the scan function.

The administrator terminal 30 is used by an administrator of the apparatus 10 in the user environment E1. An example of the administrator terminal 30 is a personal computer (PC), a personal digital assistance (PDA), a tablet-type terminal, a smart phone, a mobile phone, or the like.

The online storage system 40 is a computer system providing a cloud service called an “online storage” through the network. The online storage is a service of lending a memory area of a storage. In the first embodiment, the memory area lent by the online storage is a candidate for a delivery destination of image data in a cloud scan service provided by the service providing apparatus 20.

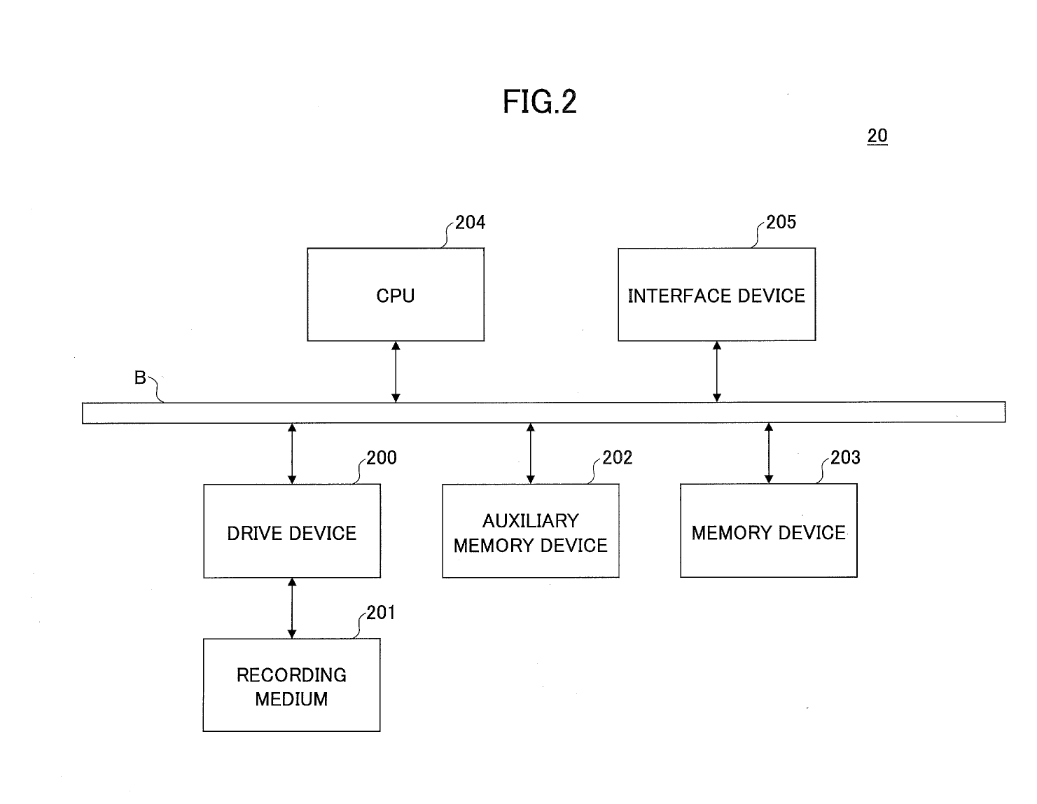

FIG. 2 illustrates an exemplary hardware structure of the service providing apparatus of the first embodiment. The service providing apparatus 20 includes a drive device 200, an auxiliary memory device 202, a memory device 203, a CPU 204, and an interface device 205, which are mutually connected through a bus B.

A program substantializing processes in the service providing apparatus 20 is supplied by a recording medium 201 such as CD-ROM. When the recording medium 201 having the program recorded on it is installed in the drive device 200, the program is installed on the auxiliary memory device 202 through the drive device 200 from the recording medium 201. However, the program may not always be installed from the recording medium 201 and may be downloaded from another computer through the network. The auxiliary memory device 202 stores necessary files, data, and so on in addition to the installed program.

The memory device 203 reads out the program from the auxiliary memory device 202 when the program is instructed to be invoked and stores the read program into the memory device 203. The CPU 204 substantializes a function related to the service providing apparatus 20 in conformity with the program stored in the memory device 203. The interface device 205 is used as an interface for connecting to the network.

The service providing apparatus 20 may be formed by multiple computers including hardware illustrated in FIG. 2. Said differently, processes performed by the service providing apparatus 20 described below may be distributed and executed by the multiple computers.

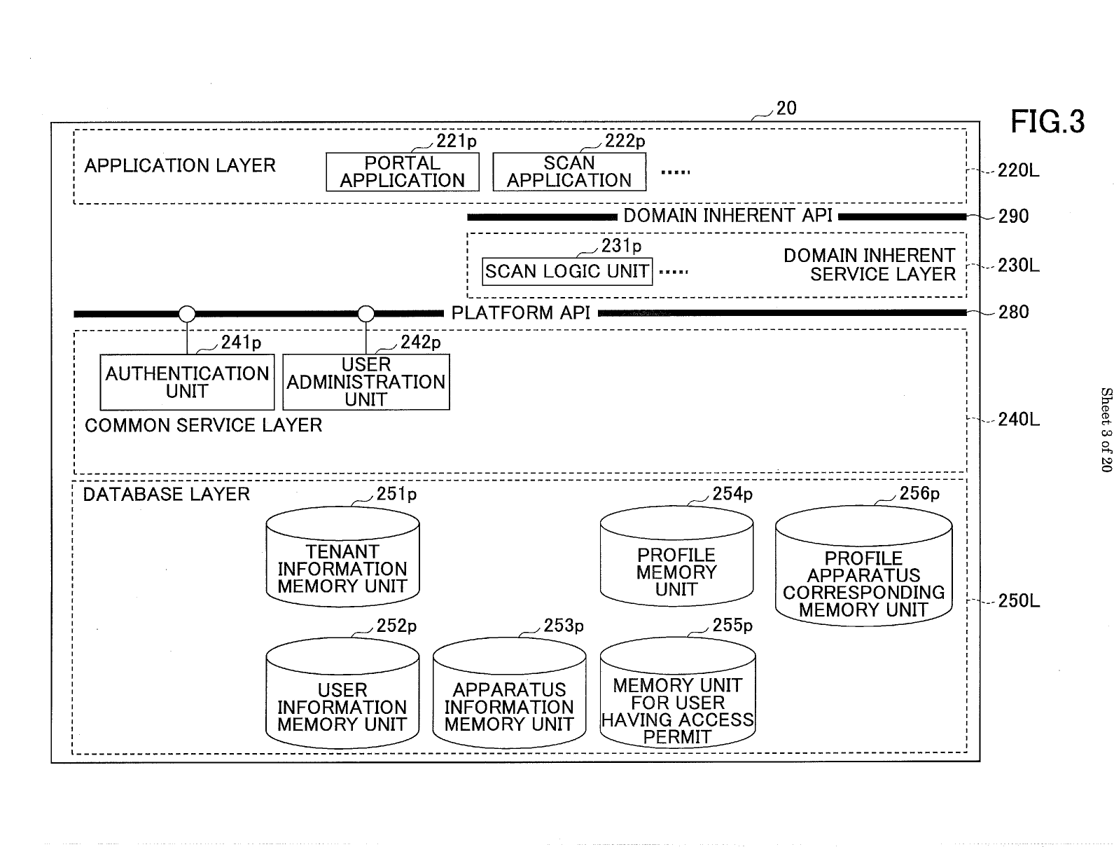

FIG. 3 illustrates an exemplary functional structure of the service providing apparatus of the first embodiment. Referring to FIG. 3, the function of the service providing apparatus 20 are classified into four layers of an application layer 220L, a domain inherent service layer 230L, a common service layer 240L, and a database layer 250L.

The application layer 220L is a layer on which an application (hereinafter, referred to as a “server application”) belonging to a side of a server and related to the cloud scan service is installed. Referring to FIG. 3, the application layer 220L includes a portal application 221p, a scan application, and so on. The portal application 221p is a server application for serving a portal site of the cloud scan service. In this portal site, for example, it is possible to perform a registration of user information, setup information for the server application for each user, or the like. The scan application 222p is the server application for performing a process on a server side for the above cloud scan service. The server application related to the service other than the cloud scan service may be added.

The common service layer 240L is a layer including a function common to multiple server applications, a basic function used by multiple server applications, or the like. The function of the common service layer 240L can be called through a platform API 280. The platform API 280 basically called from the server application in the application layer 220L or the domain inherent service layer 230L. Further, the platform API 280 may be published to a third vendor other than a manager of the service providing apparatus 20 or the like. In this case, the server application may be implemented by the third vendor or the like. Said differently, the server application is properly developed using the platform API 280 and added.

Referring to FIG. 3, the common service layer 240L includes an authentication unit 241p, a user administration unit 242p, and so on. The authentication unit 241p authenticates and permits the user who accesses the service providing apparatus 20 and the apparatus 10. The permission is a determination of whether access to a service to be accessed is possible by the user or the apparatus or not. For example, a permission is performed based on whether the license to the service to be accessed exists or not. The user administration unit 242p manages information related to the authenticated user.

The domain inherent service layer 230L is a layer providing a service having higher completeness, higher granularity, or higher applicability in comparison with the common service layer 240L. A service provided by the domain inherent service layer 230L can be used through the domain inherent API 290. The domain inherent API 290 has greater granularity than the platform API 280. The domain inherent API 290 may be published to the outside. The domain inherent service layer 230L includes a scan logic unit 231p or the like. The scan logic unit 231p performs a logic part of the cloud scan service. The logic part of the cloud scan service is a part of the functions other than user interface function of the scan application 222p. The user interface function mainly a generation function and a provision function of generating and providing WebUI (a web page). Referring to the structure illustrated in FIG. 3, the function of the scan application 222p mainly relates to the user interface function when the scan logic unit 231p is used.

Because the domain inherent service layer 230L is provided and the domain inherent API 20 is provided, it is possible to reduce the amount of the source code which is required to be implemented at a time when the other cloud service or the like collaborates with the cloud service. Said differently, when one function used by computers or method (hereinafter, referred to as a “method” calls multiple methods of the platform API 280, the method serves a function similar to the server application. Therefore, in a case where the collaboration is required to be quickly substantialized even if an existing service is served, the domain inherent API 290 is effective. Further, the server application having a complex function may be implemented using the domain inherent API 290. On the other hand, in a case where an inherent server application is required to be implemented, it is preferable to use the platform API 280.

The database layer 250L is a layer including a database storing various information. Referring to FIG. 3, the database layer 250L includes a tenant information memory unit 251p, a user information memory unit 252p, an apparatus information memory unit 253p, a profile memory unit 254p, a memory unit 255p for user having access permit, and a profile-apparatus-correspondence memory unit 256p, and so on.

The tenant information memory unit 251p stores attribute information (hereinafter, referred to as “tenant information”) for each tenant of the service providing apparatus 20. The tenant is a user unit (a contracting organization) concluding a usage contract of the cloud scan service. For example, the tenant is at least one set of users, such as an enterprise, a society, or the like. Within the first embodiment, one user environment E1 corresponds to one tenant. The tenant information includes a tenant ID for identifying the tenants or the like. The user information memory unit 252p stores attribute information (hereinafter, referred to as “user information”) for each individual user (hereinafter, simply referred to as a “user”) belonging to the tenant. The user information includes a user ID for identifying the users, a password used to authenticate the user, and so on. Further, the tenant ID to which the user belongs is included in the user information. This is because it is sufficient that uniqueness of the user ID is secured inside the tenant. Said differently, within the first embodiment, the users are identified by a combination of the tenant ID and the user ID.

The apparatus information memory unit 253p stores attribute information (hereinafter, referred to as “apparatus information”) of the apparatus 10 used in the tenant in association with the tenant ID of the tenant. The apparatus information includes identification information (hereinafter, referred to as a “machine number”) of a machine body (an individual piece) of the apparatus 10 or the like.

The profile memory unit 254 stores a profile. The profile includes structure information of the operation screen to be displayed on the apparatus 10, setup information related to a process of the cloud scan services performed in response to an operation to the operation screen, and so on. The memory unit 255p for a user having an access permit stores information indicative of availability or permissibility for each user to a predetermined structure unit (a “group” described below). Said differently, although the profile is basically defined as information common to multiple users, the memory unit 255p for user having access permit stores information indicative of availability of an access by each user. The profile-apparatus-correspondence memory unit 256p stores correspondence information between the profile and the apparatus 10.

In a case where the service providing apparatus 20 is formed by multiple computers, the application layer 220L, the domain inherent service layer 230L, the common service layer 240L, and the database layer 250L may form each one network segment. Each portion belonging to each layer may be substantialized by a computer connected to the network segment of each layer.

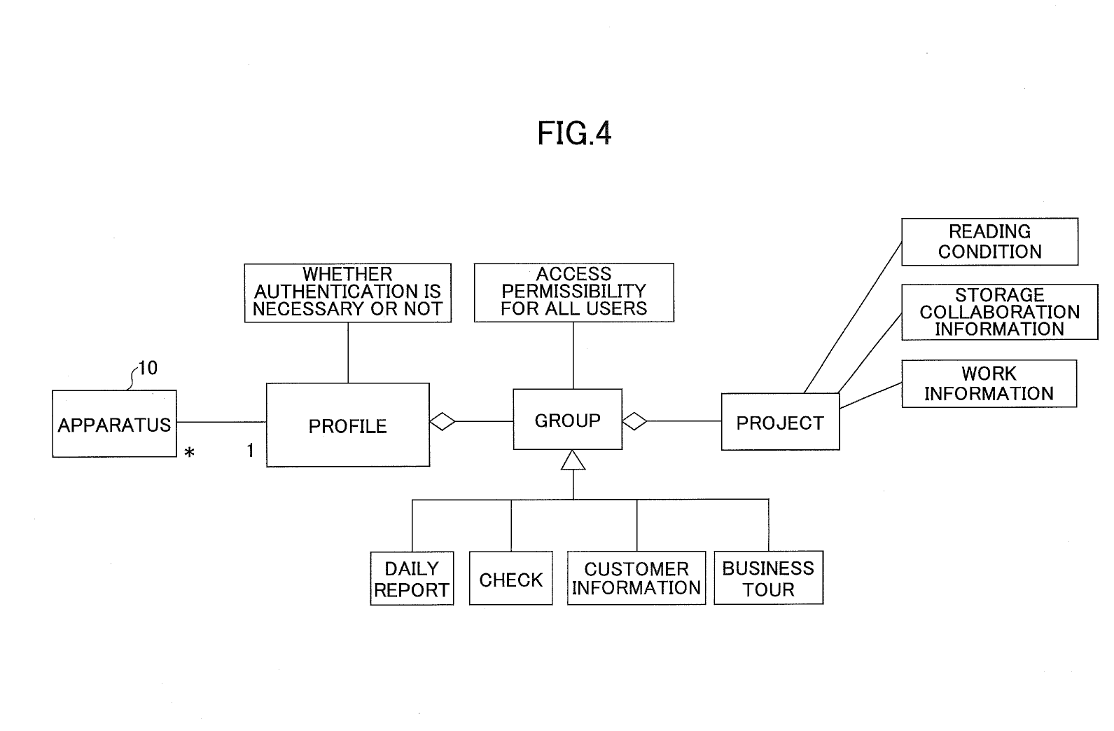

FIG. 4 is a diagram for explaining a conceptual model of the profile. As illustrated in FIG. 4, each apparatus 10 corresponds to one profile. However, multiple profiles may be set to one apparatus 10, for example, profiles different for users may be set to one apparatus 10. The profile has necessity of authentication as its attribute. The necessity of authentication is the attribute indicative of whether user authentication is necessary in using the profile.

The profile includes at least one group. The group is a concept corresponding to, for example, a tab window in the operation screen. Referring to FIG. 4, specific examples of the group are indicated as “daily report”, “check”, “customer information”, and “business tour”. These correspond to a daily report tab window, a check tab window, a customer information tab window, and a business tour tab window, respectively.

Each group includes at least one project and access permissibility for all users. The project corresponds to an operating part such as a button arranged on, for example, a tab window, and is a concept corresponding to a definition of one process flow performed in the cloud scan service.

The access permissibility for all users is information indicative of whether uses of the group are permitted for all the users or not. Said differently, the access permissibility is information indicative of whether the user who can use the group is limited. Here, “all the users” corresponds to a tenant to which the apparatus allocated with the profile belongs.

Each project includes a reading condition, storage collaboration information, work information, or the like. The reading condition is a condition in reading at a time of scanning. The storage collaboration information indicates which folder in which online storage system 40 is determined as a delivery destination for the scanned image data. The work information relates to a processing (an image processing) performed for the scanned image data before delivering the scanned image data.

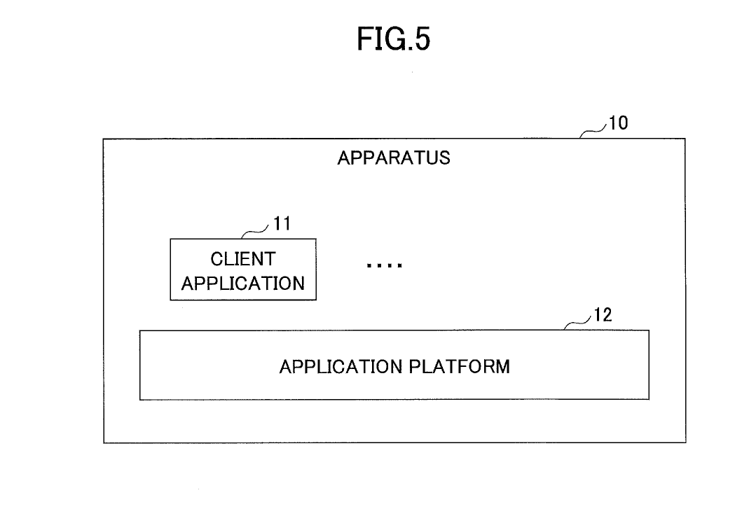

FIG. 5 illustrates an exemplary functional structure of the apparatus of the first embodiment. Referring to FIG. 5, the apparatus 10 includes a client application 11, an application platform, and so on.

The client application 11 is provided to serve the cloud scan service to the user using the domain inherent API 290. Basically, the client application 11 substantializes an UI function (a function of displaying screen), a function of controlling the apparatus 10, and so on out of the cloud scan service.

The application platform 12 includes an API for controlling the apparatus and simultaneously provides an execution environment for the client application 11. The mode of the API may be, for example, a function used by computer, a class of object-orientation, a method of the class, or the like. For example, the application platform 12 serves an API related to a scan function, an API related to a print function, an API related to a copy function, and so on to the client application 11. The application platform 12 may include a Java virtual machine (VM) (“Java” is the registered trademark). In this case, the client application 11 may be implemented using a Java language (“Java” is the registered trademark). The application platform 12 includes a mechanism for causing the service providing apparatus 20 to collaborate with the client application 11 or the like. Specifically, the application platform 12 provides a structure for causing the client application 11 to communicate with the service providing apparatus 20.

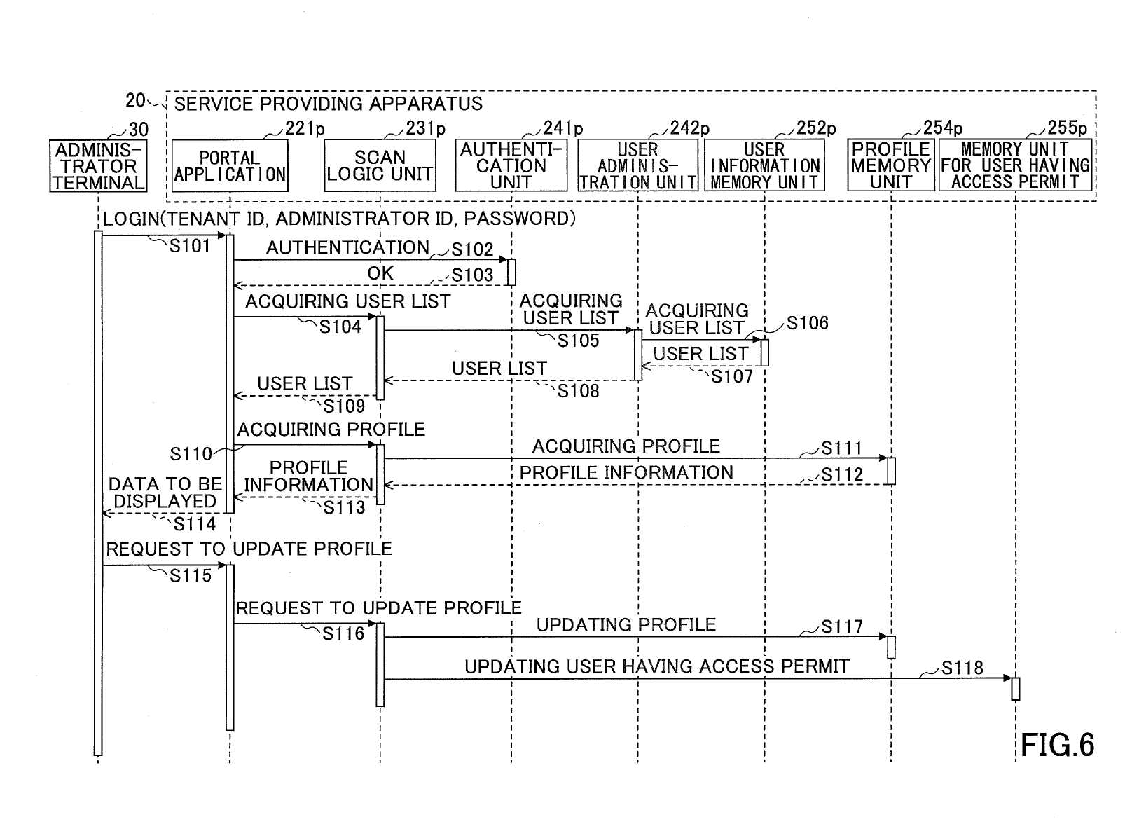

Hereinafter, the procedure performed by the information processing system 1 is described. FIG. 6 is a sequence chart for explaining an exemplary procedure of a setup process related to access permissibility to all users in a group. The process illustrated in FIG. 6 is performed in response to an operation of the administrator terminal 30 by the administrator in a tenant (hereinafter, referred to as “tenant 123”) whose tenant ID is “123”. At a time of starting the process illustrated in FIG. 6, a login screen for logging in a portal site of the service providing apparatus 20 is displayed on the administrator terminal 30.

When the administrator inputs the tenant ID, the user ID (hereinafter, referred to as an “administrator ID”), and a password on the login screen, the administrator terminal 30 sends the login request including the input information to the service providing apparatus 20 (step S101). The login request is received by the portal application 221p. The portal application 221p request the authentication unit 241p to authenticate based on the tenant ID, the administrator ID, and the password received along with the login require (step S102).

The authentication unit 241p refers to the user information memory unit 252p to determine whether the authentication is successful based on the tenant ID, the administrator ID, and the password.

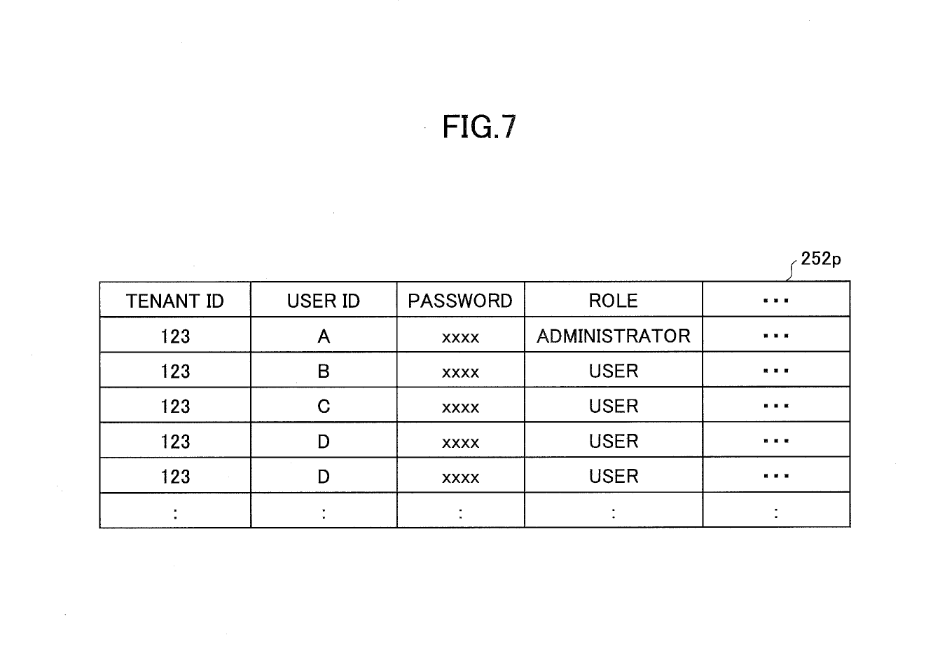

FIG. 7 illustrates an exemplary structure of the user information memory unit. Referring to FIG. 7, the user information memory unit 252p stores the tenant ID of the tenant, the user ID and the password of the user, the role of the user, or the like for each user belonging to the tenant. The role is the item name for identifying the administrator out of the users. Said differently, the user who is the administrator is registered as “administrator”, and users other than the administrator are registered as “user”.

The authentication unit 241p determines that the authentication is successful if a set of the tenant ID, the administrator ID, and the password, which are included in the authentication request, is stored in the user information memory unit 252p. The authentication unit 241p sends a response indicative of the result of the authentication to the portal application 221p (step S103). In a case where a response from the authentication unit 241p indicates the success of the authentication, processes on or after step S104 is performed. Hereinafter, the authenticated tenant ID and the authenticated administrator ID are referred to as “login tenant ID” and “login administrator ID”, respectively.

In step S104, the portal application 221p sends an acquisition request to acquire a view (hereinafter, referred to as a “user view”) of the user information to the scan logic unit 231p by designating the login tenant ID. The scan logic unit 231p transfers the acquisition request 231p to user administration unit 242p (step S105). The user administration unit 242p acquires the view (the user view) of the user information associated with the login tenant ID from the user information memory unit 252p (steps S106 and S107). The user administration unit 242p sends the acquired user view to the scan logic unit 231p (step S108). The scan logic unit 231p returns the user view to the portal application 221p (step S109). The user view includes the user IDs of all the users.

Subsequently, the portal application 221p sends an acquisition request to acquire the profile information by designating the login tenant ID (step S110). The scan logic unit 231p acquires profile information associated with the login tenant ID from the profile memory unit 254p (steps S111 and S112).

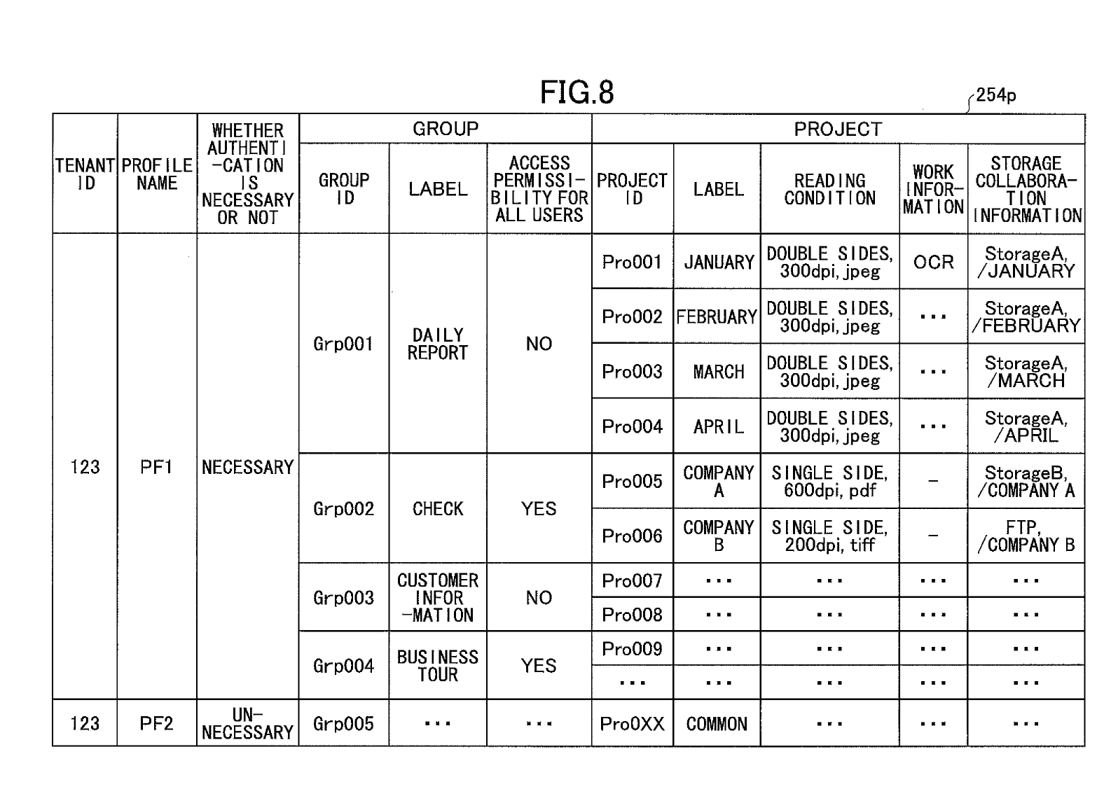

FIG. 8 illustrates a structural example of a profile memory unit. The profile memory unit 254p includes items such as the tenant ID, the profile name, the necessity of authentication, the group, and the project for each profile. Hereinafter, a record for each profile name is referred to as a “profile record”.

The tenant ID is an ID of the tenant to which the profile belongs. The profile name is a name of the profile. The necessity of authentication is an attribute indicative of whether user authentication is necessary in using the profile. The value of “necessary” indicates that the user authentication is necessary. Said differently, the value of “necessary” indicates that only the authenticated user can use the profile. The value of “unnecessary” indicates that the user authentication is unnecessary. Said differently, the value of “unnecessary” indicates that the unauthenticated user can also use the profile.

The group is included in the profile. In the records for one profile, records (hereinafter, referred to as a “group record”) for each group are formed. The project is included in the group. Inside one group record, the records (hereinafter, referred to as a “project record”) for each project are formed.

One group record includes the group ID, the label, the access permissibility for all users, and at least one project record. The group ID is identification information for each group. The label is displayed in the tab of the tab window corresponding to the group. The access permissibility for all users is as illustrated in FIG. 4. In the access permissibility for all users, any one of values “YES” or “NO” is set. The value of “YES” indicates that the use of the group by all the users is permitted, namely, the users who can use the group are not limited. The value of “NO” indicates that the use of the group by all the users is not permitted, namely, the users who can use the group are limited.

Each project record includes the projection ID, the label, the reading condition, the work information, the storage collaboration information, and so on. The project ID is identification information for each project. Within the first embodiment, the project ID inside each tenant is unique through the profiles. Therefore, one project can be specified by a combination of the tenant ID and the project ID. The label is a label of a button corresponding to the project. Within the first embodiment, the label matches the folder name of the storage collaboration information. The reading condition, the work information, and the storage collaboration information are as illustrated in FIG. 4.

In step S112, the contents of all profile records associated with the login tenant ID is acquired (hereinafter, the content of the profile record is referred to as “profile information”). The scan logic unit 231p returns the acquired profile information to the portal application 221p (step S113).

The portal application 221p generates display data causing a setup screen group related to the profile to be displayed based on the user view acquired in step S109 and the profile information acquired in step S113. The display data may be data having a versatile format such as a hypertext markup language (HTML) format. The portal application 221p returns the generated display data to the administrator terminal 30 (step S114). The administrator terminal 30 displays a main screen out of the setup screen group related to the profile based on the display data.

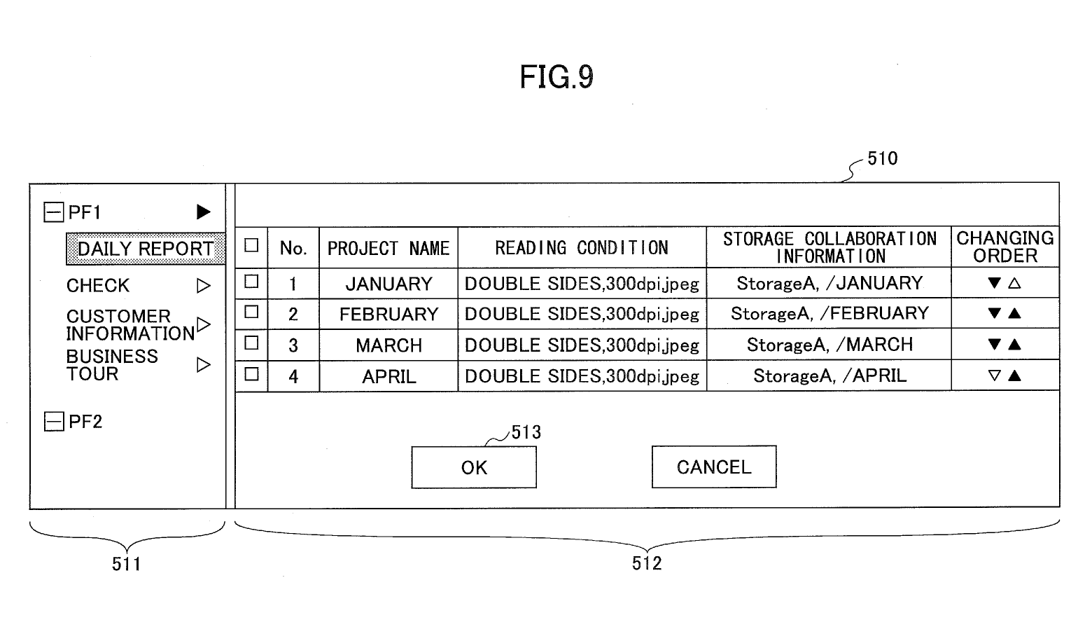

FIG. 9 illustrates an exemplary display of the main screen. The main screen 510 illustrated in FIG. 9 includes a group selection area 511 and a project display area 512.

On the group selection area 511, displayed is a tree structure where the profile is allocated to a node of a first hierarchy and the groups belonging to each profile are allocated to a node of a second hierarchy.

For example, on the group selection area 511, when a node corresponding to any one of the profiles is right-clicked, a context menu having an option of “necessary” or “unnecessary” of the necessity of authentication is displayed. By operating the context menu, the necessity of authentication to the profile is set up.

On the project display area 512, the project information is displayed in a format of table for each project belonging to the group selected on the group selection area 511. Said differently, one row of the table corresponds to one project. By operating (selecting) marks “▾” or “▴”, in a column of “changing order” on the table, the order of the rows can be changed by replacing the rows. The order of the rows corresponds to an order of displaying button corresponding to the projects. The order of the project on the table matches the order of arranging the project records in the profile memory unit 254p. Referring to FIG. 9, the label of each profile is displayed as the profile name.

For example, on the group selection area 511, if the node corresponding to any one of groups is right-clicked, the context menu including the menu item for each setup item for the group is displayed. If the menu items for the setup of the access permissibility for all users are selected on this context menu, the screen to be displayed transits to the screen 520 for selecting user having the access permit, by which the group is edited.

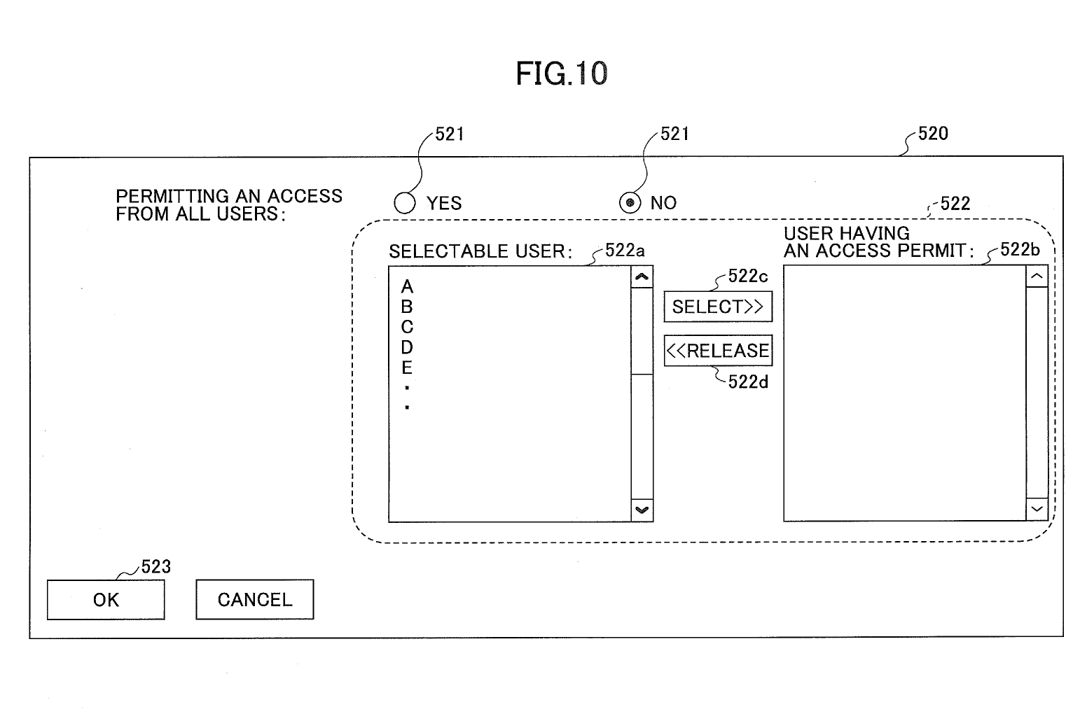

FIG. 10 illustrates a display example of the screen for selecting the user having the access permit. Referring to FIG. 10, the screen 520 for selecting the user having the access permit includes a toggle button 521 and a user selection area 522. The toggle button 521 is provided to select whether uses by all the users are permitted for the group to be edited. Said differently, the value of “YES” of the toggle button is selected in a case where the uses by all the users are permitted. Said differently, the value of “NO” of the toggle button 521 is selected in a case where the uses by all the users are not permitted. The setup using the toggle button 521 corresponds to the access permissibility for all users of the group.

The user selection area 522 becomes operable in a case where “NO” is selected on the toggle button 521. The user selection area 522 includes a list box 522a, a list box 522b, a button 522c, a button 522d, and so on. In the list box 522a, a view of the user IDs contained in the user view acquired in step S109 is displayed as selection candidates. Said differently, the user IDs of all the users belonging to the tenant related to the login tenant ID are displayed. When at least one user ID is selected on the list box 522a and the button 522c is pushed, the selected user ID moves to the list box 522b. The list box 522b includes the user ID of the user to whom the use of the group to be edited is permitted. Hereinafter, a user corresponding to the user ID who is moved to the list box 522b is referred to as a “user having the access permit”. When at least one user ID is selected on the list box 522b and the button 522d is pushed, the selected user ID moves to the list box 522a.

If the setup using the toggle button 521 and the user selection area 522 is completed and an OK button 523 is pushed, a setup content on the screen 520 for selecting the user having the access permit is held and the screen to be displayed transits to the main screen 510.

If the OK button 513 is pushed on the main screen 510, the administrator terminal 30 sends an update request to update the profile including the setup content set on the main screen 510 and the screen for selecting user having the access permit to the service providing apparatus 20 (step S115). The setup content includes the view (hereinafter, referred to as a “user view of the users having the access permit”) of the user ID included in the list box 522b of the screen for selecting user having the access permit 520. If the portal application 221p receives the update request, the portal application 221p transfers the update request to the scan logic unit 231p (step S116).

When the scan logic unit 231p receives the update require, the scan logic unit 231p updates the profile information stored in the profile memory unit 254p based on the setup content included in the update request (step S117). For example, a value of whether the authentication is permitted or not or the like is updated. Further, the value of the access permissibility for all the users of the group record is updated. Specifically, FIG. 8 corresponds to a case where the necessity of authentication of the profile whose profile name is “PF1” is set to “necessary”. Further, FIG. 8 corresponds to an example where the access permissibility for all the users of the group whose group ID is “Grp001” or “Grp003” is set to “NO”. Said differently, FIG. 8 corresponds to an example where “NO” is selected in the toggle button 521 of the screen 520 for selecting user having the access permit. Hereinafter, in a case where the groups are distinguished for each group ID, the groups are indicated in a format of “group <group ID>”. For example, the group whose group ID is “Grp001” is indicated as “group Grp001”.

Subsequently, the scan logic unit 231p updates the content of the memory unit 255p for the user having the access permit based on the user view of the users having the access permit included in the result of the edit (step S118).

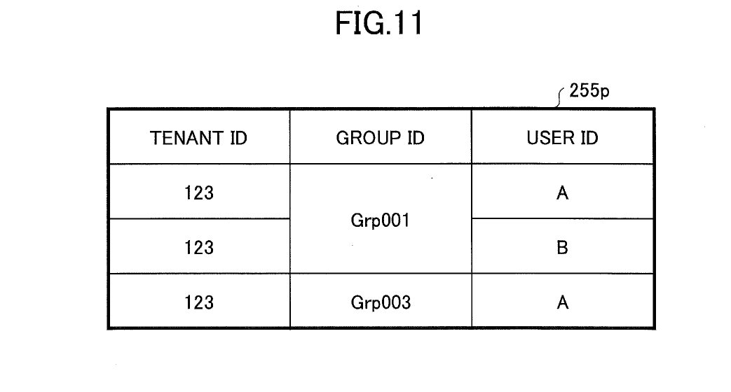

FIG. 11 illustrates an exemplary structure of a memory unit for the user having the access permit. Referring to FIG. 11, the memory unit 255p for the user having the access permit includes items such as the tenant ID, the group ID, the user ID, and so on. Said differently, the memory unit 255p for the user having the access permit stores the user ID of the user having the access permit for each of the groups specified by the tenant ID and the group ID.

In step S118, the user ID permitted to use the group for each of the groups to be edited on the screen for selecting user having the access permit is stored in the memory unit 255p for the user having the access permit.

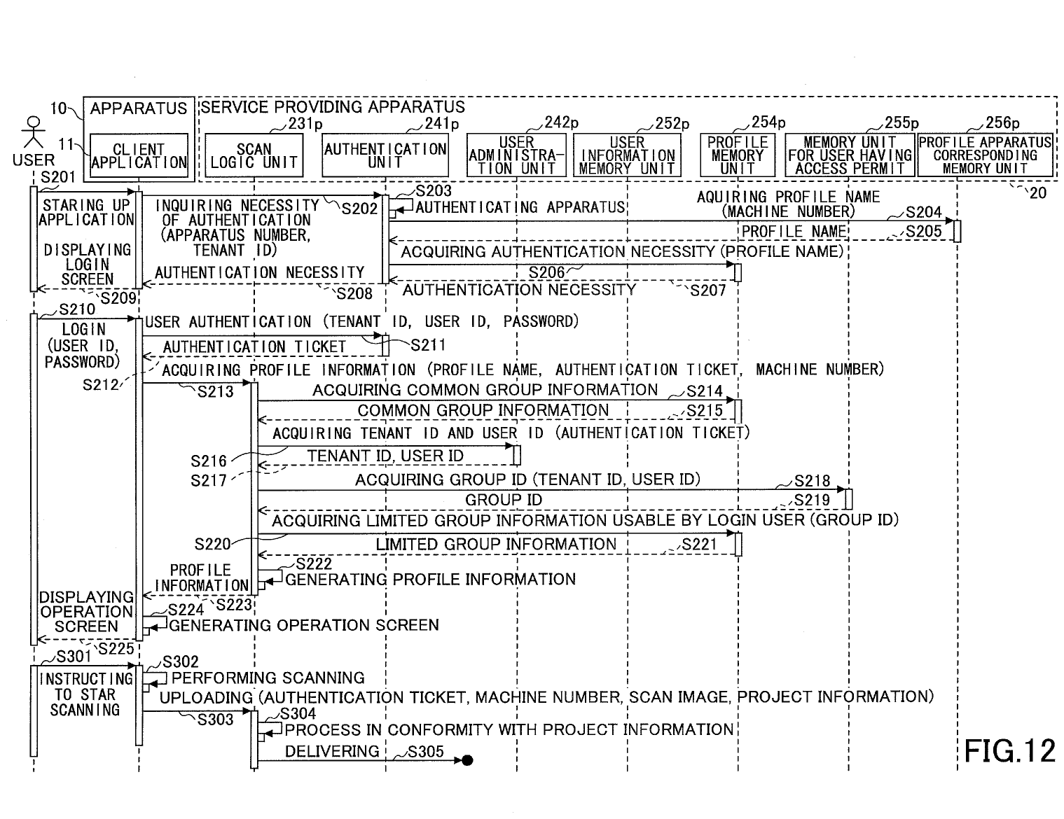

Subsequently, a procedure of performing jobs of the cloud scan services is described. FIG. 12 is a sequence chart illustrating an exemplary procedure at a time of performing the job of the cloud scan service. The process illustrated in FIG. 12 is performed in response to the operation of the apparatus 10 by a user belonging to the tenant 123. The user A is a user whose user ID is “A”. The other users are called in a way similar to the above.

In step S201, the apparatus 10 starts up the client application in response to an operation instruction instructed by user A. The client application 11 sends an inquiry of whether the user authentication is required to the authentication unit 241p of the service providing apparatus 20 after the client application 11 is started up (step S202). In the inquiry, the machine number of the apparatus 10 and the tenant ID of the apparatus 10 are included in the authentication information of the apparatus 10. Here, the machine number and the tenant ID are previously stored in, for example, the apparatus 10.

The authentication unit 241p performs the authentication for the apparatus 10 being an inquiry source based on the machine number and the tenant ID, which are included in the inquiry, in response to the inquiry (step S203). The authentication is successful if the machine number is stored in the apparatus information memory unit 253p in association with the tenant ID. In a case where the authentication is successful, the steps on or after step S204 is performed. Hereinafter, the machine number and the tenant ID used for the authentication in step S203 are referred to as a target machine number and a target tenant ID, respectively.

In steps S204 and S205, the authentication unit 241p acquires a profile name corresponding to the target machine number from the profile-apparatus-correspondence memory unit 256p.

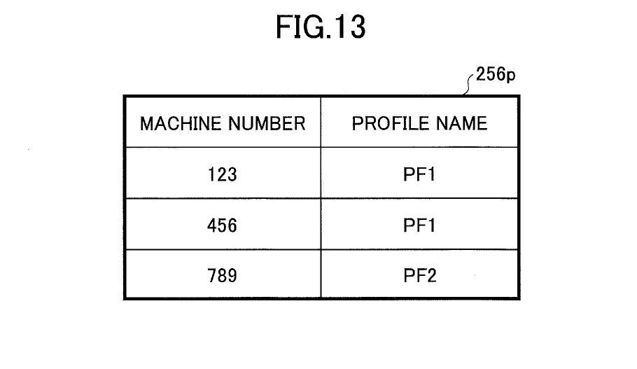

FIG. 13 illustrates a structural example of the profile-apparatus-correspondence memory unit. As illustrated in FIG. 13, the profile-apparatus-correspondence memory unit 256p stores the profile name in association with the machine number. The correspondence between the machine number and the profile name in the profile-apparatus-correspondence memory unit 256p substantializes a correspondence relationship between the apparatus 10 and the profile in FIG. 4.

Subsequently, the authentication unit 241p acquires a value of the item of the necessity of authentication for the profile related to the acquired profile name from the profile memory unit 254p (see FIG. 8) (steps S206 and S207). Within the first embodiment, the profile name is unique through the tenants. However, in a case where the uniqueness of the profile name is secured only inside the tenant, it is sufficient in steps S206 and S207 to acquire the target tenant ID and the value of the item of the necessity of authentication for the profile corresponding to the acquired profile name.

Subsequently, the authentication unit 241p returns the acquired value (“necessary” or “unnecessary”) to the client application 11 (step S208). In a case where the returned value is “necessary”, the client application 11 causes the operation panel of the apparatus to display the login screen (step S209).

When the user ID and the password are input into the login screen by the user (step S210), the client application 11 sends a user authentication including the user ID, the password, and the tenant ID that is stored in the apparatus 10 to the authentication unit 241p (step S211). If the set of the tenant ID, the administrator ID, and the password is stored in the user information memory unit 252p, the authentication unit 241p determines that the authentication is successful.

In a case where the authentication is successful, the authentication unit 241p generates an authentication ticket. The generated authentication ticket is associated with the tenant ID and the user ID, with which the authentication is successful, by the user administration unit 242p and stored in, for example, the memory device 203. The authentication ticket is data indicative of the authenticated user. The authentication ticket may be implemented by, for example, a cookie. Further, the authentication ticket may have an expiry date. Subsequently, the authentication unit 241p returns the authentication to the client application 11 (step S212). The user corresponding to the authentication ticket, namely the user who is successfully authenticated, is referred to as a “login user”. In a case where the authentication is failed, the authentication ticket is not generated and a response indicative of the failed authentication is returned to the client application 11. In this case, steps on or after step S213 are not performed.

When the authentication ticket is returned, the client application 11 sends an acquisition request to acquire the profile information including the profile name, the authentication ticket, and the machine number to the scan logic unit 231p (step S213). The profile name is included in the acquisition request to acquire the profile information in a case where the profile information is acquired (downloaded) by the apparatus in the past. Therefore, in a case where the profile information is initially acquired by the apparatus 10, the profile name is not included in the acquisition request. In this case, the scan logic unit 231p receiving the acquisition request acquires the profile name corresponding to the machine number included in the acquisition require from the profile-apparatus-correspondence memory unit 256p before performing step S214. Each request from the client application on or after step S213 includes the authentication ticket, and the authenticity of the authentication ticket is checked every time by the user administration unit 242p. However, the check process is omitted in the sequence chart for convenience. In the check process, it is checked whether the user ID is stored in the memory device 203 in association with the authentication ticket, whether the authentication ticket is within the expiry date, or the like. In a case where the authenticity of the authentication ticket is not checked, the request from the client application 11 is refused.

Subsequently, the scan logic unit 231p acquires the common group information out of the information (hereinafter, referred to as “group information”) of the group record included in the profile (hereinafter, referred to as a “target profile”) corresponding to the profile name included the acquisition request to acquire the profile (steps S214 and S215). The common group information is information of the group, of which value of the access permissibility for all the users is “YES” (said differently, all the users can use the group). Therefore, in the example illustrated FIG. 8, the group information of the groups Grp002 and Grp004 corresponds to the common group information.

Subsequently, the scan logic unit 231p sends the acquisition request to acquire the tenant ID and the user ID to the user administration unit 242p (step S216). The acquisition request includes the authentication ticket. The user administration unit 242p returns the tenant ID and the user ID, which are stored in the memory device 203 in association with the authentication ticket” in association with the authentication ticket included in the acquisition request (step of S217).

Subsequently, the scan logic unit 231p acquires the group ID stored in association with the tenant ID and the user ID from the memory unit 255p for the user having the access permit (FIG. 11) (steps S218 and S219). Subsequently, the scan logic unit 231p acquires limited group information related to the group ID acquired in step S219 out of the group information included in the target profile from the profile memory unit 254p (FIG. 8) (steps S220 and S221). The limited group information is information of the group, of which value of the access permissibility for all the users is “NO” (said differently, the users who can use are limited). Therefore, in the example illustrated FIG. 8, the group information of the groups Grp001 and Grp003 corresponds to the limited group information. In step S221, the limited group information related to the group Id acquired in step S219 is acquired out of the limited group information.

Subsequently, the scan logic unit 231p generates profile information, in which the acquired common group information and the acquired limited group information are integrated (step S222). The profile name of the generated profile information is the profile name of the target profile. Subsequently, the scan logic unit 231p returns the generated profile information to the client application 11 (step S223).

The client application 11 generates an operation screen of the cloud scan service based on the received profile information (step S224). Subsequently, the client application 11 causes the operation screen to be displayed on the operation panel of the apparatus 10. The client application 11 stores the profile information into a memory device of the apparatus 10. For example, the profile name of the profile information stored here is included in the acquisition request to acquire the profile information in step S213.

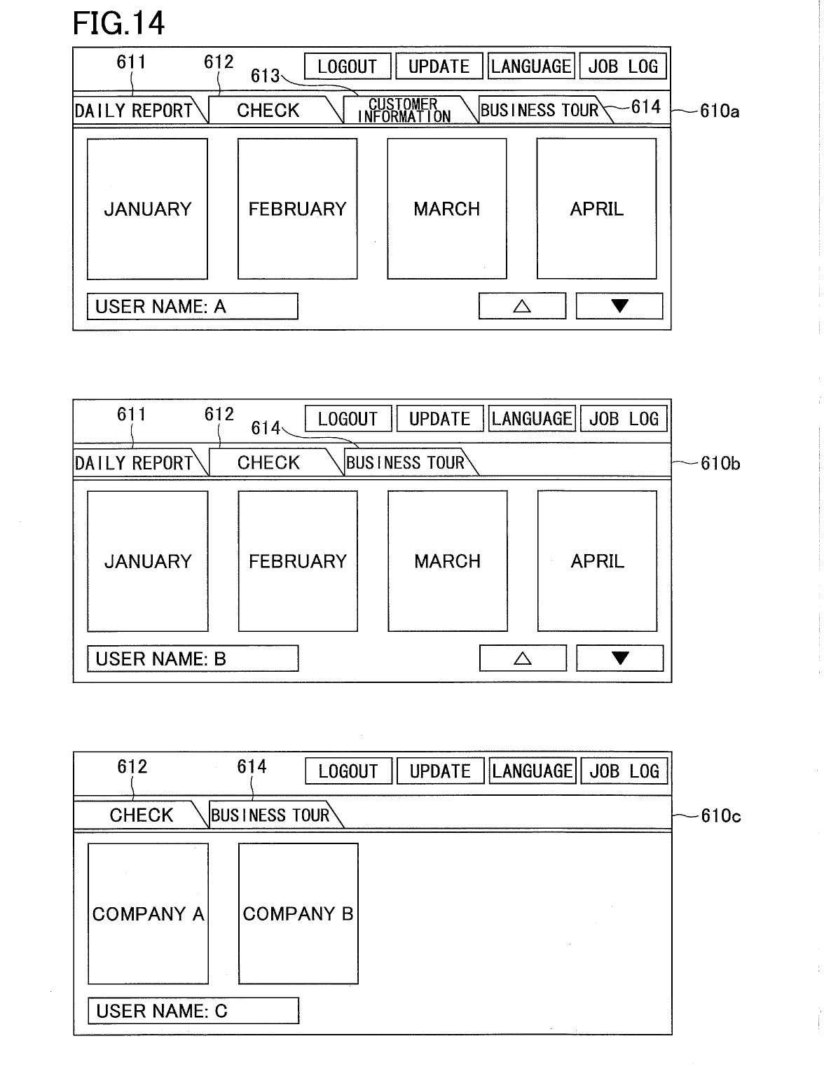

FIG. 14 illustrates an exemplary operation screen displayed based on profile information. FIG. 14 illustrates an example of the operation screen displayed in response to who the login user is among user A, user B, or the others, in a case where the profile, whose profile name is “PF1” illustrated in FIG. 8, is the target profile. In the target profile, the group information of groups Grp002 and Grp004 corresponds to the common group and the group information of groups Grp001 and Grp003 corresponds to the limited group.

An operation screen 610a is an operation screen displayed in a case where user A is the login user. Referring to FIG. 11, the limited group which can be used by user A is group Grp001 and group Grp003. Therefore, on the operation screen 610a, tab windows 611 to 614 corresponding to all the groups belonging to the target profile are operable.

An operation screen 610b is an operation screen displayed in a case where user B is the login user. Referring to FIG. 11, the limited group which can be used by user B is group Grp001. Said differently, the user B cannot use group Grp003. Therefore, the tab windows 611, 612, and 614 corresponding to the groups other than group Grp003 are operable on the operation screen 610b.

An operation screen 610c is an operation screen displayed in a case where the login user is neither user A nor user B. Referring to FIG. 11, there is no limited group which can be used by this login user. Therefore, the tab windows 612 and 614 corresponding to the groups other than group Grp001 and group Grp003 are operable on the operation screen 610c. Because the login user is user A, the operation screen 610a is displayed.

When an original is set to the apparatus 10 and a start instruction to start scanning is input (step S301) in a state where user A selects the tab window 611 corresponding to, for example, group Grp001 (“daily report”) on the operation screen 610a and selects a button corresponding to project Pro001 (“January”) in the tab window 611, the client application 11 causes the apparatus 10 to scan in conformity with the reading condition of project Pro001 (step S302). The image data obtained by scanning the original is referred to as a “scanned image”.

Subsequently, the client application 11 uploads the scanned image into the scan logic unit 231p together with the authentication ticket, the machine number, and the project information (step S303). The project information is of the project selected on the operation screen 610a. In step S303, the upload including the project information is an example of an execution request (a processing request) of the process corresponding to the project ID included in the project information.

Subsequently, the scan logic unit 231p performs a process in conformity with the uploaded project information with respect to the scanned image which is uploaded (step S304). For example, if optical character recognition (OCR) is designated in work information of the project information, an OCR process is performed for the scanned image. Subsequently, the scan logic unit 231p delivers data generated as a result of processing in conformity with the project information to a delivery destination in conformity with the storage collaboration information of the project information (step S305). The data generated as a result of processing in conformity with the project information are, for example, text data output as a result of the OCR process in a case where the scanned image is provided with the OCR process.

The process illustrated in FIG. 12 is performed based on any apparatus 10 as long as the apparatuses 10 are allocated with the same profile. The profile is stored in the service providing apparatus 20, and each apparatus 10 downloads the profile information allocated to the apparatus 10 in the profile-apparatus-correspondence memory unit 256p. Therefore, in a case where any one of the apparatuses 10 allocated with the same profile is used, the job can be performed by user A using the profile information based on the same common group information and the same limited group information.

Subsequently, described is the procedure performed in a case where the apparatus 100 allocated with the profile whose necessity of authentication is “NO” is to be operated (the operation target).

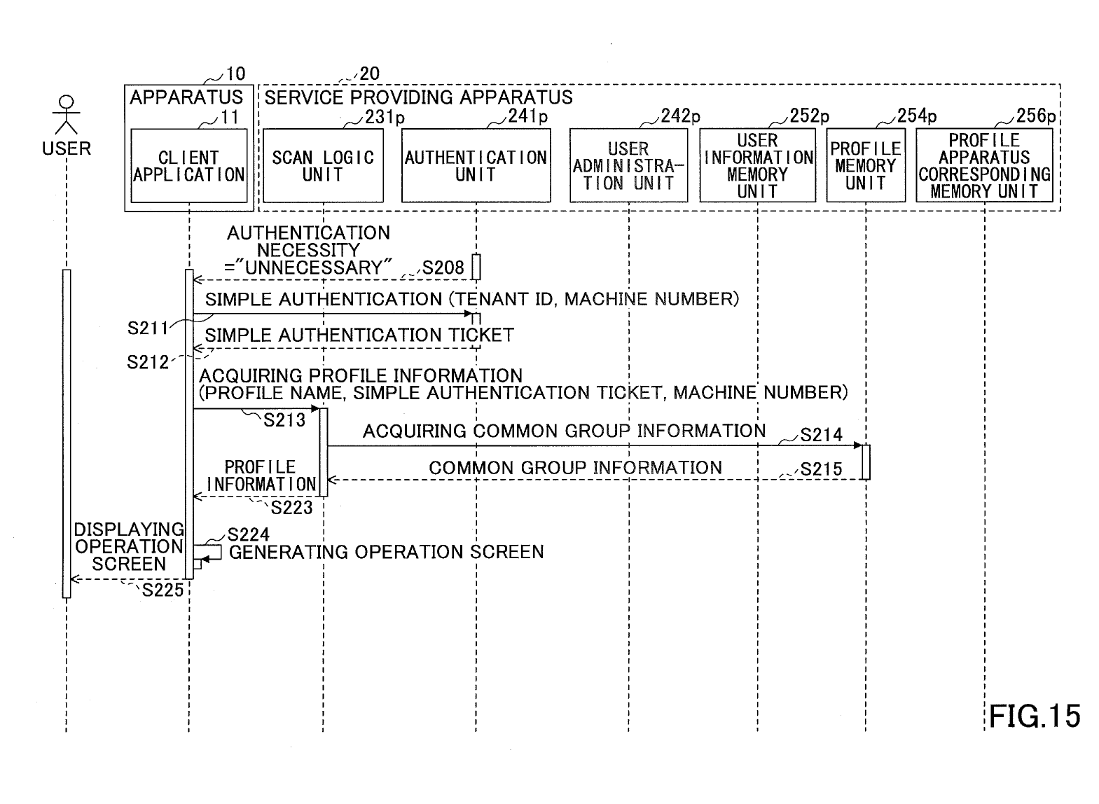

FIG. 15 is a sequence chart for explaining an exemplary procedure of a job of the cloud scan service related to the apparatus to which a profile requiring no authentication is allocated. Referring to FIG. 15, the same reference symbols as in FIG. 12 are attached to the same or corresponding steps.

Referring to FIG. 15, steps S201 to S207 are omitted for convenience. In step S208, the authentication unit 241p returns a response indicating that the necessity of authentication is “unnecessary” to the client application 11.

In response to an event that the authentication is unnecessary, the client application 11 sends a simple authentication request including the tenant ID and the machine number to the authentication unit 241p (step S211). Said differently, in a case where the authentication is unnecessary, a display of the login screen, inputs of the user ID and the password, or the like is not performed. Further, the simple authentication is requested to the authentication unit 241p instead of the user authentication. The simple authentication is substantially the same as the apparatus authentication described in step S203 of FIG. 12.

The authentication unit 241p determines that the simple authentication is successful if the tenant ID and the machine number designated in the simple authentication request is stored in the apparatus information memory unit 253p. If the simple authentication is successful, the authentication unit 241p returns a simple authentication ticket to the client application 11 (step S212). The user administration unit 242p stores the simple authentication ticket in association with the tenant ID and the machine number in, for example, the memory device 203.

Subsequently, the client application 11 sends an acquisition request to acquire the profile information including the profile name, the simple authentication ticket, and the machine number to the scan logic unit 231p (step S213). Subsequently, the scan logic unit 231p acquires the common group information out of the project information included in the profile related to the profile name included in the acquisition request to acquire the profile information from the profile memory unit 254p (FIG. 8) (steps S214 and S215).

Subsequently, the scan logic unit 231p returns the profile information formed by the common group information to the client application 11 (step S223). Said differently, the scan logic unit 231p performs step S223 without performing steps S216 to S222 in a case where the authentication ticket included in the acquisition request to acquire the profile information is the simple authentication ticket. A distinction between the authentication ticket and the simple authentication ticket may be done based on, for example, a mutual difference of their structures. Alternatively, in a case where these structures are the same, the authentication ticket and the simple authentication ticket may be distinguished based on a difference between information corresponding to the authentication ticket and information corresponding to the simple authentication ticket. Said differently, the authentication ticket illustrated in FIG. 12 corresponds to the tenant ID and the user ID. On the other hand, the simple authentication ticket corresponds to the tenant ID and the machine number.

Steps on or after step S224 performs the procedure described with reference to FIG. 12. However, an operation screen 610c (FIG. 14) is displayed as the operation screen. Said differently, a tab window corresponding to the group related to the common group information is displayed on the operation screen.

As described above, within the first embodiment, it is possible to set the permissibility of the use for each user. Said differently, it is possible to provide a limitation to the operation for each user. Therefore, it is possible to improve flexibility of the limitation to the operation of the screen for using the cloud scan service.

### Second Embodiment

Next, a second embodiment is described. Differences between the second embodiment and the first embodiment are described below. Features of the second embodiment, which are not specifically described, are substantially the same as those of the first embodiment.

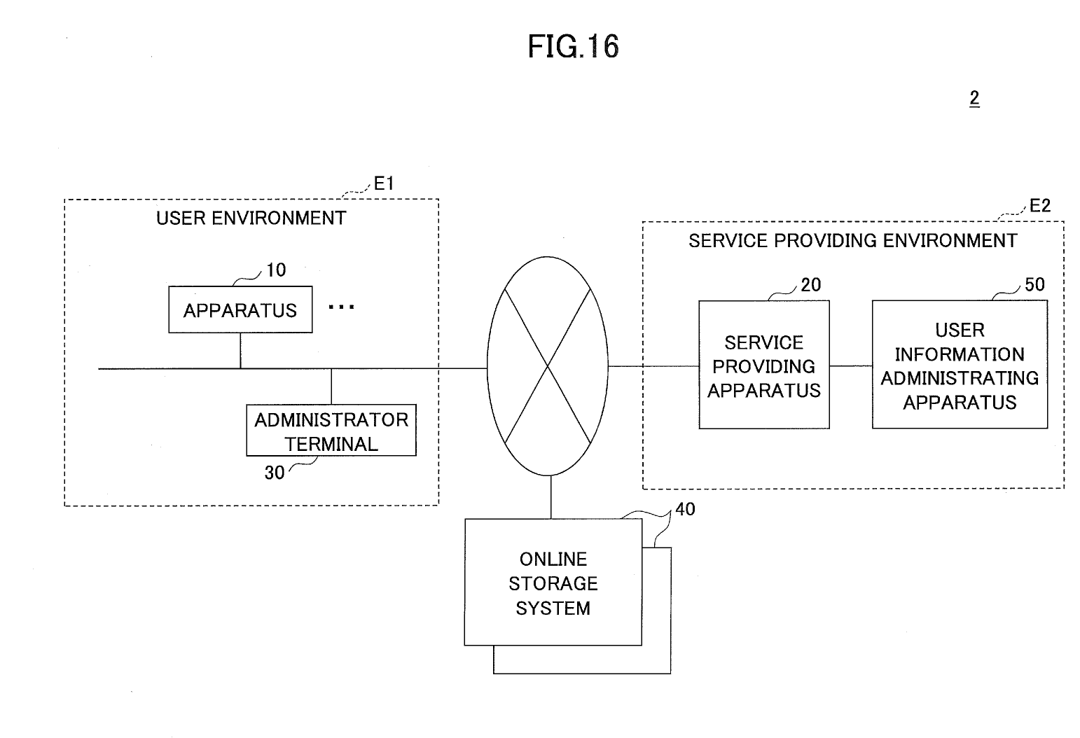

FIG. 16 illustrates an exemplary structure of the information processing system of the second embodiment. Referring to FIG. 16, the same reference symbols as those in FIG. 1 are given to the same portions as or portions similar to those in FIG. 1, and explanation of these portions is omitted.

In the information processing system 2 illustrated in FIG. 16, the service providing environment E2 further includes a user information administration apparatus 50. The user information administration apparatus 50 is connected to the service providing apparatus 20 so as to be communicable through a network such as LAN or the Internet. The user information administration apparatus 50 includes at least one computer having, for example, a hardware structure as illustrated in FIG. 2.

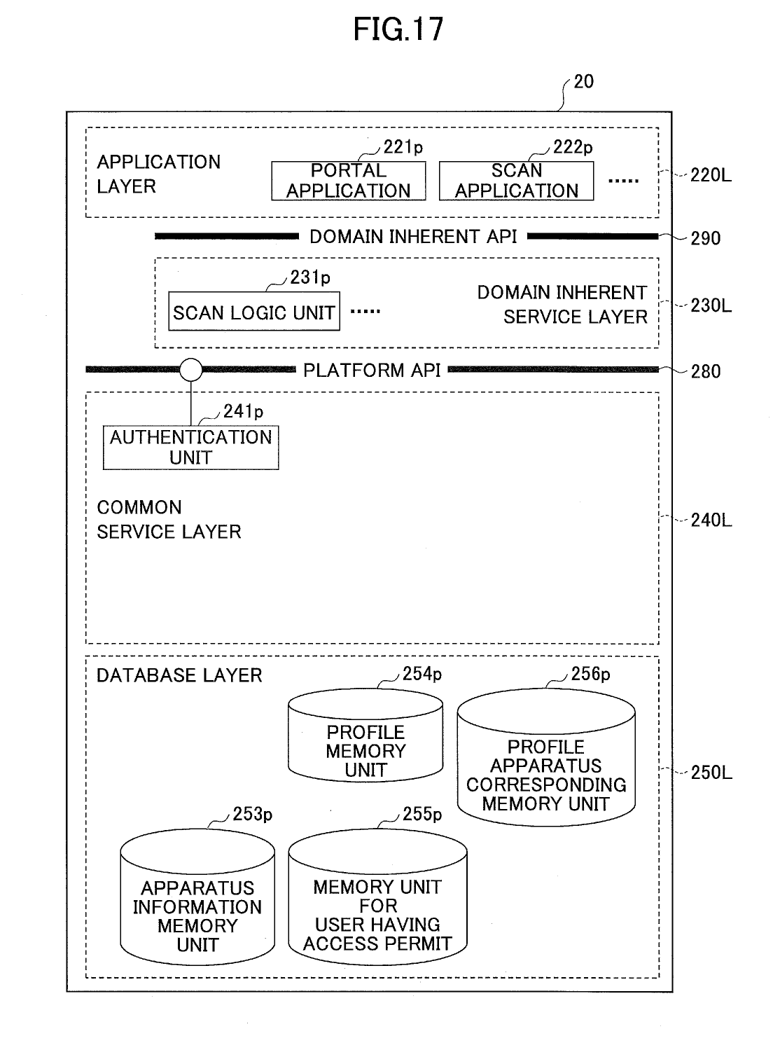

FIG. 17 illustrates an exemplary functional structure of the service providing apparatus of the second embodiment. Referring to FIG. 17, the same reference symbols as those in FIG. 3 are given to the same portions, and explanation of these portions is omitted.

As illustrated in FIG. 17, within the second embodiment, the service providing apparatus 20 may not include the user administration unit 242p, the tenant information memory unit 251p, and the user information memory unit 252p. This is because the user information administration apparatus 50 includes the user administration unit 242p, the tenant information memory unit 251p, and the user information memory unit 252p.

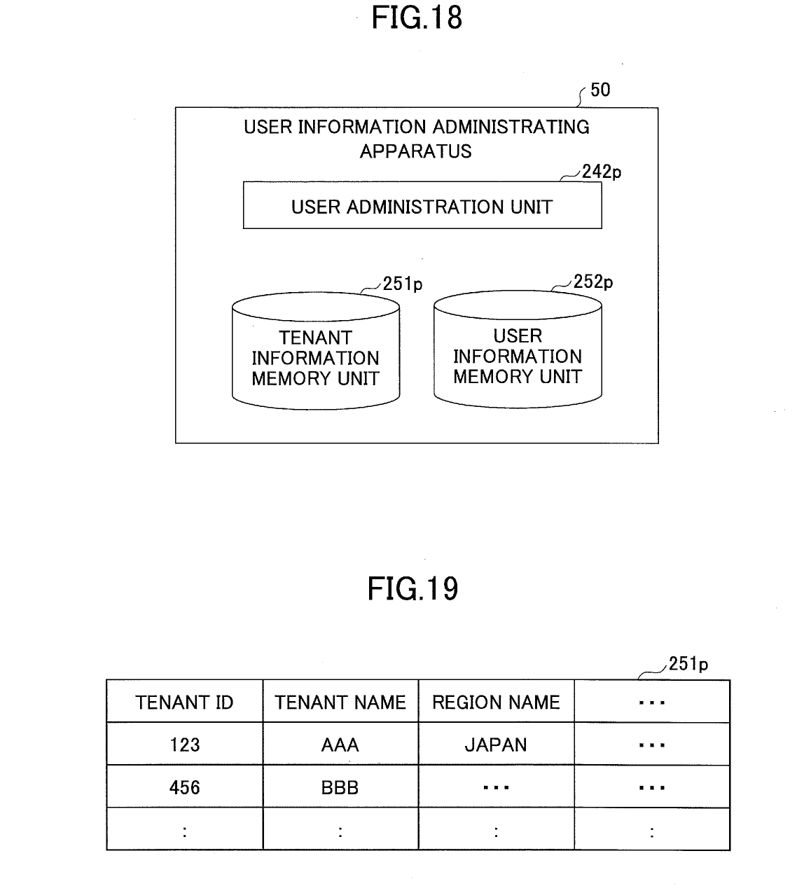

FIG. 18 illustrates an exemplary functional structure of the user information administration apparatus of the second embodiment. Referring to FIG. 18, the user information administration apparatus 50 includes the user administration unit 242p, the tenant information memory unit 251p, and the user information memory unit 252p. The user administration unit 242p is substantialized by a process caused by a program installed on the user information administration apparatus 50 to be performed by the CPU of the user information administration apparatus 50. The tenant information memory unit 251p and the user information memory unit 252p are substantialized by using an auxiliary memory device or the like of the user information administration apparatus 50. Said differently, within the second embodiment, the user administration unit 242p, the tenant information memory unit 251p, and the user information memory unit 252p are substantialized by a computer or a computer group different from the computer or the computer group of the service providing apparatus 20.

FIG. 19 illustrates an exemplary structure of the tenant information memory unit. Referring to FIG. 19, the tenant information memory unit 251p stores the tenant information for each tenant. The tenant information includes, for example, the tenant ID, the tenant name, the region name, or the like. The tenant name is the name of the tenant. The region name is the name of a sales region to which the tenant belongs. The structure of the tenant information memory unit 251p may be common between the first embodiment and the second embodiment.

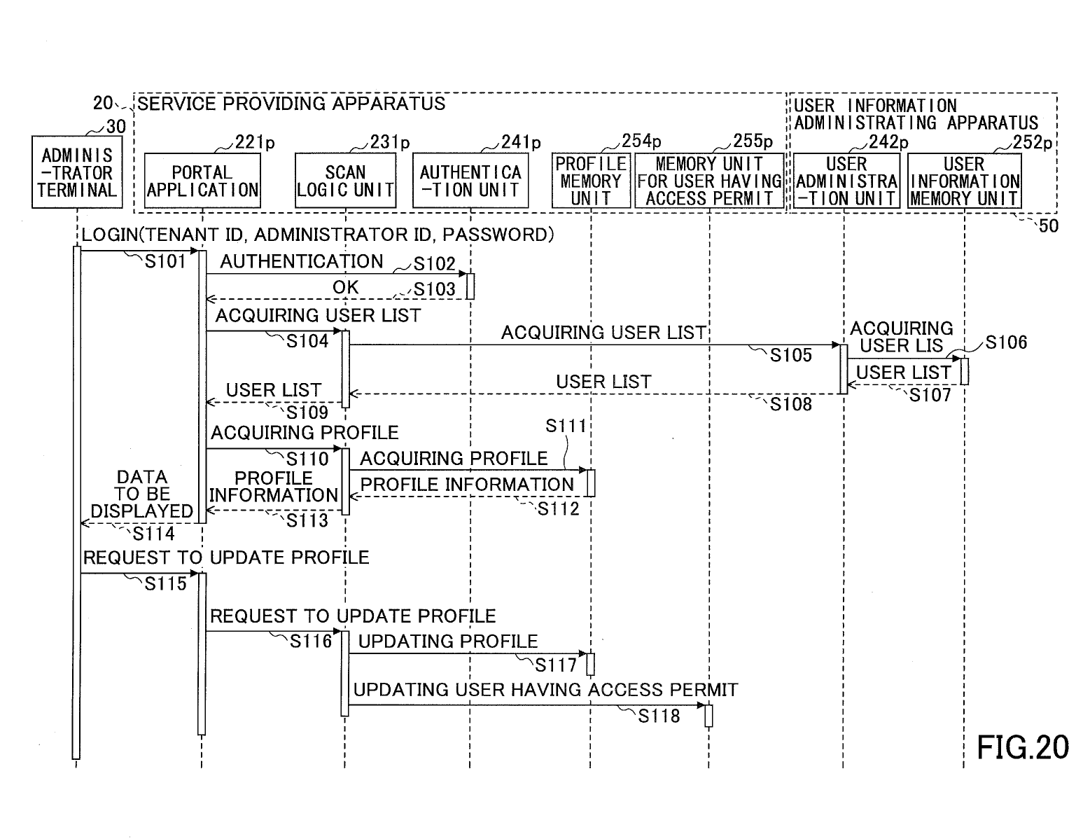

FIG. 20 is a sequence chart for explaining an exemplary procedure of a setup process related to access permissibility for all the users in a group of the second embodiment. Referring to FIG. 20, the same step numbers as those in FIG. 6 are given to the same steps as or corresponding steps of those in FIG. 6, and explanation of these steps is omitted.

Referring to FIG. 20, in step S105, the scan logic unit 231p transfers the acquisition request to acquire a user view to the user administration unit 242p of the user information administration apparatus 50 through the network. The user administration unit 242p acquires the user view corresponding to the login tenant ID designated in the acquisition request from the user information memory unit 252p (steps S106 and S107). The user administration unit 242p returns the acquired user view to the scan logic unit 231p through the network (step S108).

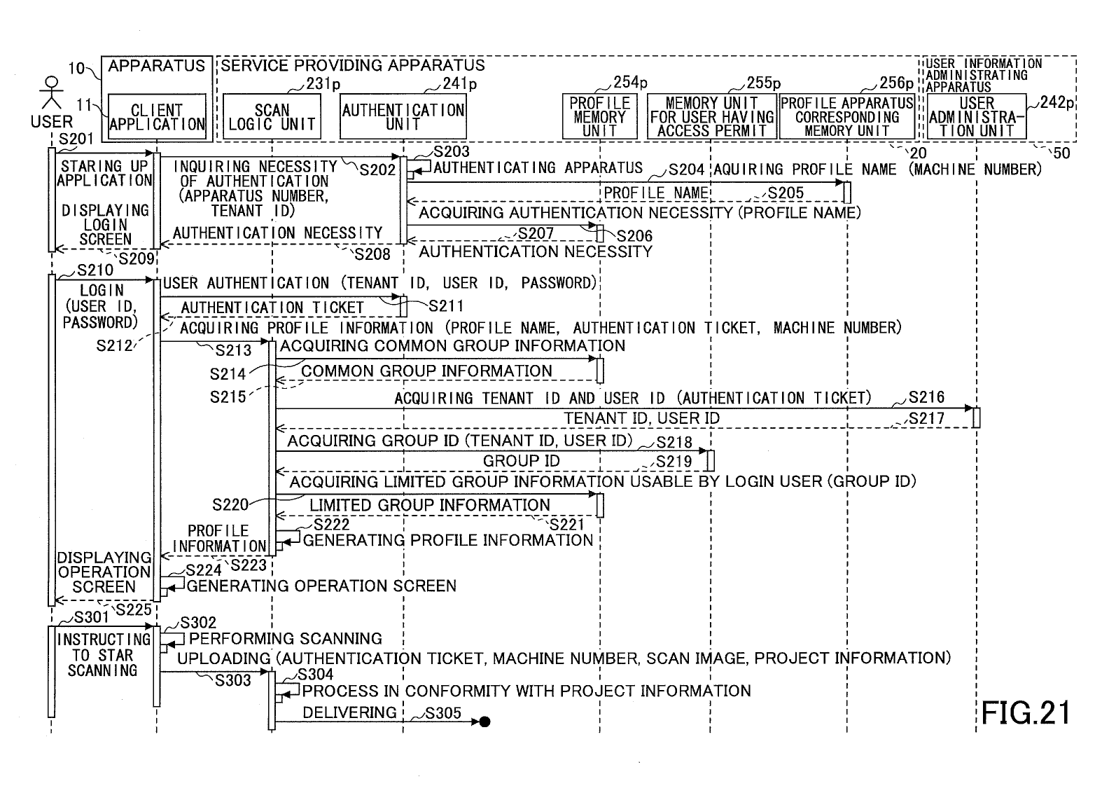

FIG. 21 is a sequence chart illustrating an exemplary procedure at a time of performing the job of the cloud scan service of the second embodiment. Referring to FIG. 21, the same step numbers as those in FIG. 12 are given to the same steps as or corresponding steps of those in FIG. 12, and explanation of these steps is omitted.

Referring to FIG. 21, in step S216, the scan logic unit 231p sends the acquisition request to acquire the tenant ID and the user ID of the login user to the user administration unit 242p. The user administration unit 242p returns the tenant ID and the user ID, which are stored in association with the authentication ticket included in the acquisition request, to the scan logic unit 231p through the network (step of S217).

As described, within the second embodiment, the user administration unit 242p, the tenant information memory unit 251p, and the user information memory unit 252p are substantialized by a computer different from the computer of the service providing apparatus 20. Therefore, even in a case where the service providing apparatus 20 is installed in, for example, each region or each country, the tenant information and the user information can be uniformly (globally) managed for multiple service providing apparatuses 20.

Although, within the first and second embodiments, a case where the image forming apparatus is the specific example of the apparatus 10 is described, a mobile phone, a smart phone, a tablet-type terminal, a personal computer (PC), a digital camera, or the like may be an input source (a transmission source) of the image data for the service providing apparatus 20.

Within the embodiments, the service providing apparatus 20 is an example of an information processing system for claims 1-3 and 5 and a service providing system for claim 4. The user ID is an example of user identification information. One profile is an example of screen information common to multiple users. The limited group information is an example of a portion associated with the user identification information. The common group information is an example of a portion associated with no user identification information. The authentication controlling unit 241p is an example of a receiving unit. The scan logic unit 231p is an example of the returning unit and the processing unit. The user information administration apparatus 50 is an example of a user managing system.

It is possible to improve flexibility of a limitation to an operation of a screen in using a service served through a network.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although an information processing system has been described in detail, it should be understood that various changes, substitutions, and alterations could be made thereto without departing from the spirit and scope of the invention.

This application is based upon and claims the benefit of priority of the prior Japanese Patent Application No. 2013-243854, filed on Nov. 26, 2013, and the Japanese Patent Application No. 2014-231266, filed on Nov. 14, 2014, the entire contents of which are incorporated herein by reference.

What is claimed is:

1. An information processing system including at least one computer, the information processing system comprising:
a receiving unit that receives user identification information from an apparatus connected through a network;
a returning unit that returns a portion which is associated with the user identification information received by the receiving unit out of screen information which is stored in association with the apparatus and is common to a plurality of users, in response to an acquisition request to acquire the screen information from the apparatus; and
a processing unit that receives a request which is sent from the apparatus in response to an input into a screen displayed based on the returned portion.

2. The information processing system according to claim 1,
wherein the returning unit returns another portion which is associated with none of the user identification information in addition to the portion which is associated with the user identification information received by the receiving unit.

3. The information processing system according to claim 1,
wherein the portion corresponds to a tab on the screen displayed based on the screen information.

4. An information processing system including a service providing system at least one computer and a user managing system including at least one computer, wherein the service providing system comprising:
a receiving unit that receives any one of user identification information stored in the user managing system from an apparatus connected through a network;
a returning unit that returns a portion which is associated with the user identification information received by the receiving unit
out of screen information which is stored in association with the apparatus and is common to a plurality of users in response to an acquisition request to acquire the screen information from the apparatus; and
a processing unit that receives a request which is sent from the apparatus in response to an input into a screen displayed based on the returned portion.

5. A method of processing information by a processing system including at least one computer, the method comprising:
receiving user identification information from an apparatus connected to the information processing system through a network;
returning a portion which is associated with the user identification information received by the receiving out of screen information which is stored in association with the apparatus and is common to a plurality of users in response to an acquisition request to acquire the screen information from the apparatus; and
processing by receiving a request which is sent from the apparatus in response to an input into a screen displayed based on the returned portion and performing a process in conformity with the request.
